(19) United States
(12) Patent Application Publication
(10) Pub. No.: US 2018/0168204 A1
(43) Pub. Date: Jun. 21, 2018

(54) PROCESS-STABLE OPACIFYING COMPOSITIONS FOR FOOD PRODUCTS AND METHODS

(71) Applicant: Campbell Soup Company, Camden, NJ (US)

(72) Inventor: Keswara Rao Vadlamani, Marlton, NJ (US)

(21) Appl. No.: 15/838,703

(22) Filed: Dec. 12, 2017

Related U.S. Application Data
(60) Provisional application No. 62/435,464, filed on Dec. 16, 2016.

(51) Int. Cl. A23L 5/42; A23L 29/212; A23C 11/02; A23L 23/00; A21D 13/40; A21D 2/18

(52) U.S. Cl. CPC A23L 5/42; A23L 29/212; A23C 11/02; A23V 2002/00; A21D 13/40; A21D 2/186; A23L 23/00

(57) ABSTRACT

Embodiments herein include opacifying compositions, food products made with the same, and related methods. In an embodiment, a processed food product is included. The processed food product can include a modified food starch with at least 70 wt. % fiber and a milk mineral concentrate with at least 24 wt. % calcium. The brightness (L*) value of the processed food product is greater than 70. Other embodiments are also included herein.

This application claims the benefit of U.S. Provisional Application No. 62/435,464, filed Dec. 16, 2016, the content of which is herein incorporated by reference in its entirety.

### FIELD

Embodiments herein relate to opacifying compositions for food products and related methods. More specifically, embodiments herein relate to process-stable opacifying compositions for food products and related methods.

### BACKGROUND

Titanium dioxide is a common additive and widely used to provide whiteness and opacity to products such as paints, plastics, papers, inks, foods, and toothpastes. It is also used in cosmetic and skin care products, and it is present in almost every sunblock, where it helps protect the skin from ultraviolet light. It also functions as an anti-caking agent, texturizer (chocolate, doughnuts), and as an abrasive agent (toothpaste).

Titanium dioxide accounts for 70% of the total production volume of pigments worldwide. Titanium dioxide is an inert and insoluble material, and not easily absorbed into the body from food. Titanium dioxide is considered Generally Recognized as Safe (GRAS) by the U.S. Food and Drug Administration.

However, consumer demand for natural and clean-label ingredients is a leading and ongoing trend that requires developing new food products with consumer friendly ingredients, while delivering on taste and appearance. Titanium dioxide has been used as a whitening agent in many food products in the past, but its use is increasingly not perceived positively by consumers.

### SUMMARY

Embodiments herein include opacifying compositions, food products made with the same, and related methods. In an embodiment, a processed food product is included. The processed food product can include a modified food starch with at least 70 wt. % fiber and a milk mineral concentrate with at least 24 wt. % calcium. The brightness (L*) value of the processed food product is greater than 70.

In an embodiment, an opacifying composition is included having a modified food starch with at least 70 wt. % fiber and a milk mineral concentrate with at least 24 wt. % calcium. The brightness (L*) value of the composition is greater than 70.

In an embodiment, a method of making a processed food product is included herein. The method can include adding an opacifying composition to a formulation an opacifying composition including a modified food starch with at least 70 wt. % dietary fiber and a milk mineral concentrate with at least 24 wt. % calcium. The method can further include forming an emulsion with the formulation and the opacifying composition. The method can further include blending the emulsion with other components to form a mixture. The method can further include processing the mixture to form a finished product.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following drawings, in which:

FIG. 1 is a graph showing the synergistic effect of the opacifying compositions.

FIG. 2 is a graph showing the comparative whitening effect of TiO₂ and titanium dioxide-free opacifying blends.

While embodiments are susceptible to various modifications and alternative forms, specifics thereof have been shown by way of example and drawings, and will be described in detail. It should be understood, however, that the scope herein is not limited to the particular embodiments described. On the contrary, the intention is to cover modifications, equivalents, and alternatives falling within the spirit and scope herein.

### DETAILED DESCRIPTION

In view of recent consumer concern about titanium dioxide, there is a need for alternative whitening agents for foods. Current alternatives to titanium dioxide include ingredients such as calcium carbonate and rice starch. However, calcium carbonate and rice starch do not perform well in some food compositions, especially soups and baked snacks. Moreover, these ingredients have limitations. For example, calcium carbonate changes the pH of the food systems, makes it chalky, provides a dull white appearance, and imparts an undesirable flavor. Rice starch is not suitable for canned soup application. During retort processing, rice starch gelatinizes and loses its opacity. Rice starch also imparts high viscosity.

Embodiments herein address the unmet need for consumer-friendly titanium dioxide free whitening compositions for application in high-moisture and heat-processed products such as soups, dips, and baked snacks.

Various embodiments herein include titanium-dioxide free food compositions. The term “titanium-dioxide free” as used herein shall refer to food compositions with no added titanium dioxide and therefore including only whatever trace amounts of titanium dioxide may be included within other components of food formulations.

Various embodiments herein include food compositions with very low amounts of titanium dioxide. By way of example, food compositions herein can include less than 0.75, 0.5, 0.4, 0.3, 0.2, 0.1, 0.05, or 0.01 wt. % titanium dioxide.

It has been discovered herein that combining (i) a unique highly cross-linked modified food starch (RS4 resistant starch), and (ii) a natural milk mineral concentrate rich in calcium produced by special isolation process from milk, in specific proportions results in opacifying blends that are highly process tolerant, neutral to pH and taste, and highly synergistic in opacifying/whitening of food products.

### Starch

Starch consists of two kinds of glucose polymers (amylose and amylopectin). Depending on the plant, starch generally contains 20-25% amylose and 75-80% amylopectin. In general, grain-derived starches have a higher amylose content than tuber-derived starches. Table 1 below shows the characteristics of some starch granules.

TABLE 1
Characteristics of some starch granules

Size of Grain (in μm)

| Starch | Type | Range | Average | Shape |
|---|---|---|---|---|
| potato | tuber | 5-100 | 40 | oval |
| | | | | spherical |
| maize | grain | 2-30 | 15 | round |
| | | | | polygonal |
| wheat | grain | 1-45 | 25 | round |
| | | | | lenticular |
| tapioca | root | 4-35 | 25 | oval |
| | | | | truncate |
| waxy | grain | 3-26 | 15 | round |
| maize | | | | polygonal |

Starches used herein can have an average grain size of about 5, 10, 15, 20, 25, 30, 35, 40, 45, 50, 55, or 60 μm. In some embodiments, the starches used herein can have a grain size in a range wherein any of the foregoing grain sizes can serve as the upper or lower bound of the range, provided that the upper bound is greater than the lower bound.

Cross-linking is a modification method used to improve the performance of native starches. Cross-linking reinforces the granules of starch to be more resistant to degradation from pH, heat, and shear. One such cross-linking technique performed on starch is by chemical modification with sodium trimetaphosphate and sodium tripolyphosphate under controlled conditions to create a highly cross-linked starch. The important property of this starch is that it is resistant to digestion and considered a dietary fiber. In various embodiments, the starch is a type RS4 resistant starch.

The modified food starch can contain at least about 60%, 65%, 70%, 75%, 80%, 85%, 90%, or 95% total dietary fiber as measured by AOAC method 991.43. In some embodiments, the modified food starch can contain an amount of dietary fiber in a range wherein any of the foregoing amounts can serve as the upper or lower bound of the range, provided that the upper bound is greater than the lower bound. In some embodiments, the modified food starch can contain at least about 70% total dietary fiber as measured by AOAC method 991.43.

Examples of starches with significant fiber content are sold under the trade names of FIBERSYM RW (Midwest Grain Products, Inc.); ACTISTAR RT (Cargill) and VERSAFIBE or NOVELOSE (Ingredion).

In various embodiments, the modified food starch is low in calories, has low water binding capacity (0.7 g water/g) neutral in flavor, smooth non-gritty texture and process tolerant.

In some embodiments, the modified food starch has less than 2.0, 1.5, 1.0, 0.75, 0.5, 0.25 or 0.10 kcal/g. In some embodiments, the modified food starch has an amount of kilocalories per gram that is in a range wherein any of the foregoing amounts can serve as the upper or lower bound of the range, provided that the upper bound is greater than the lower bound. In some embodiments, the modified food starch has less than 0.5 kcal/g.

In some embodiments, the modified food starch has a water binding capacity of less than 1.9 g water/g, 1.7 g water/g, 1.5 g water/g, 1.3 g water/g, 1.1 g water/g, 0.9 g water/g, 0.7 g water/g, 0.5 g water/g, 0.3 g water/g, or 0.1 g water/g. In some embodiments, the modified food starch has an amount of water binding capacity that is in a range wherein any of the foregoing amounts can serve as the upper or lower bound of the range, provided that the upper bound is greater than the lower bound. In some embodiments, the modified food starch has a water binding capacity of less than 0.7 g water/g.

The total amount of the modified food starch added to a food product can vary based on a number of factors including the desired degree of opacity, the starting color of the food product, and the like. In various embodiments, the amount of modified food starch, as a percent of the total weight of the food product including all other ingredients, can be about 0.1, 0.25, 0.5, 0.75, 1, 2, 3, 4, 5, 7.5, 10, 12.5, 15, 17.5 or 20 wt. %. In some embodiments, the amount of modified food starch can be in a range wherein any of the foregoing amounts can serve as the upper or lower bound of the range, provide that the upper bound is greater than the lower bound.

### Milk Mineral Concentrate

Milk mineral concentrates used herein include special calcium-rich ingredient produced by specialized processes. In various embodiments, the milk mineral concentrate is in the form of a white free-flowing powder. The particle sizes can vary. In some embodiments, the average particle size is less than 50 μm, 40 μm, 30 μm, 25 μm, 20 μm, 15 μm, 10 μm, 7.5 μm, 5 μm, 2.5 or 1 μm. In some embodiments, the average particle size in a range wherein any of the foregoing can serve as the upper or lower bound of the range, provided that the upper bound is greater than the lower bound.

In various embodiments 85% of particles are under 5 μm and 99% of particles are under 20 μm.

The total amount of the milk mineral concentrate added to a food product can vary based on a number of factors including the desired degree of opacity, the starting color of the food product, and the like. In various embodiments, the amount of milk mineral concentrate, as a percent of the total weight of the food product including all other ingredients, can be about 0.1, 0.25, 0.5, 0.75, 1, 2, 3, 4, 5, 7.5, 10, 12.5, 15, 17.5 or 20 wt. %. In some embodiments, the amount of milk mineral concentrate can be in a range wherein any of the foregoing amounts can serve as the upper or lower bound of the range, provide that the upper bound is greater than the lower bound.

In some embodiments, the milk mineral concentrate can have a pH range of greater than 5.0, 5.5, 6.0, 6.5, 7.0, or 7.5. In some embodiments, the milk mineral concentrate can have a pH range of less than 8.0, 7.5, 7.0, 6.5, or 6.0. In some embodiments, the milk mineral concentrate can have a pH in a range wherein any of the foregoing numbers can serve as the upper or lower bound of the range. In some embodiments, the milk mineral concentrate can have a pH of 6.5-7.3.

Milk mineral concentrates herein have a relatively low amount of protein and are therefore quite distinct from many other types of dairy-based ingredients. In some embodiments, the milk mineral concentrate has less than 10, 7.5, 5, 2.5 or 1 wt. % protein. In some embodiments, the milk mineral concentrate has a protein content in a range wherein any of the foregoing amounts can serve as the upper or lower bound of the range, provided that the upper bound is greater than the lower bound.

Milk mineral concentrates herein have a high calcium content. In various embodiments, the milk mineral concentrate has a calcium content of greater than 15, 17.5, 20, 22.5, 25, 27.5, 30, 32.5, 35, 37.5 or 40 wt. %. In various embodiments, the milk mineral concentrate can have a calcium concentrate in a range wherein any of the foregoing amounts can serve as the upper or lower bound of the range, provided that the upper bound is greater than the lower bound. In some embodiments, the milk mineral concentrate can have a calcium content from 24 to 28% calcium.

Milk mineral concentrates herein have a very high total mineral content. In some embodiments the milk mineral concentrate has a total mineral content of 55, 60, 65, 70, 75, 80, 85, 90 or 95 wt. % total mineral content. In some embodiments, the milk mineral concentrate can have a total mineral content in a range between any of the foregoing numbers, provided that the upper bound of the range is greater than the lower bound. In some embodiments, the milk mineral concentrate has a total mineral content of about 70 to 76 wt. %. In some embodiments, the milk mineral concentrate has a total mineral content of about 72 to 74 wt. %. In some embodiments, the milk mineral concentrate has a total mineral content of about 73 wt. %.

Exemplary milk mineral concentrates are commercially available as CAPOLAC MM-0525 BG, manufactured by Arla Food Ingredients and CALCIANE manufactured by Lactalis Ingredients.

### Opacifying Blends:

In various embodiments, the modified food starch content can be about 10, 15, 25, 30, 35, 40, 45, 50, 55, 60, 65, 70, 75, 80, 85, or 90% of the opacifying blend composition. In some embodiments, the modified food starch content can be in a range wherein any of the foregoing numbers can serve as the upper or lower bound of the range. In an embodiment, the modified food starch content can be up to 30%, 50%, 65%, 75% or 85% of the total opacifying composition.

In various embodiments, the milk mineral concentrate content can be about 10, 15, 25, 30, 35, 40, 45, 50, 55, 60, 65, 70, 75, 80, 85, or 90% of the opacifying blend composition. In some embodiments, the milk mineral concentrate content can be in a range wherein any of the foregoing numbers can serve as the upper or lower bound of the range. In an embodiment, the milk mineral concentrate content can be up to 10%, 15%, 25%, 35% 50%, or 65% of the total opacifying composition.

In some embodiments, the opacifying composition can contain from about 65 to about 85 wt. % starch and about 15 to about 35 wt. % milk mineral concentrate. In some embodiments the opacifying composition can contain from about 3.5 to about 8.5 wt. % calcium (as a percentage of the total weight of the opacifying composition).

### Processed Food Products and Other Ingredients

Processed foods herein can include and but not limited to: reduced-fat/low-fat, refrigerated and shelf-stable soups, cheese dips, white sauces, salad dressings, bakery products, baked snacks, and confectionary fillings and coatings.

Some processed food products herein can be low-fat. In various embodiments, processed food products can contain less than 10, 7.5, 5, 2.5 or 1 gram of fat per serving, or an amount of fat falling within a range between any of the foregoing. In some embodiments, processed food products herein can contain less than 5 grams of fat per 8 ounce serving.

Some processed food products herein can be low in calories. In various embodiments, processed food products herein can contain less than 200, 175, 150, 125, 100, 75 or 50 calories (kcals) per serving, or an amount of calories falling within a range between any of the foregoing. In some embodiments, processed food products herein can contain less than 100 calories per serving.

The total amount of the opacifying composition or blend in the processed food product can vary. In some embodiments the processed food product can include about 0.1, 0.5, 1, 1.5, 2, 3, 4, 5, 6, 8, 10, 12, 14, or 16 wt. % of the opacifying composition or blend. In some embodiments, the amount of the opacifying composition or blend in the processed food product can be in a range wherein any of the foregoing numbers can serve as the upper or lower bound of the range, provided that the upper bound is greater than the lower bound. In some embodiments, the processed food product can contain from 1 wt. % to 6 wt. % of the modified food starch and milk the mineral concentrate combined.

Some processed food products such as soups herein can contain other ingredients including, but not limited to, one or more of fresh cream, butter, liquid oils such as canola, soy bean, etc., thickening agents such as starches, hydrocolloids and wheat flour, soy protein, whey protein, meat broths, meats, pasta, cheeses, vegetables, salt, sugar, yeast extracts, monosodium glutamate, and flavorings.

Some processed food products such as dips here in can contain other ingredients including, but not limited to, cheeses (cheddar, monterey jack); thickeners (modified starches, maltodextrins), hydrocolloids (xanthan gum, guar gum, carrageenan, cellulose, etc.), liquid oils (soy, canola, etc.); buffering agents (citrate and phosphate salts), acidulants (lactic acid, vinegar); emulsifiers (DATEM, mono and di glycerides), dehydrated vegetables, salt, and flavorings.

Some processed food products such as white sauces here in can contain other ingredients including, but not limited to, cheeses (cheddar, monterey jack, etc.); thickeners (modified starches, maltodextrins), hydrocolloids (xanthan gum, guar gum, carrageenan, cellulose, etc.), liquid oils (soy, canola, etc.); buffering agents (citrate and phosphate salts), acidulants (lactic acid, vinegar); emulsifiers (DATEM, mono and di glycerides, lecithin), dehydrated vegetables, salt, and flavorings.

Some processed food products such as bakery products and baked snacks here in can contain other ingredients including, but not limited to, flours (wheat, rice, tapioca, potato, sorghum, etc.); cheeses (cheddar, monterey jack, parmesan, romano, etc.); thickening agents (modified starches, maltodextrins), hydrocolloids (xanthan gum, guar gum, carrageenan, cellulose, etc.), liquid oils (soy, canola, etc.); leavening agents (sodium bicarbonate, ammonium bicarbonate), salt, sugar, yeast, yeast extracts, spices and flavors.

Some processed food products such as confectionary coatings and fillings herein can contain other ingredients including, but not limited to, fats and oils (soy, canola, etc.) sugars, flours (wheat, rice, tapioca, potato); thickening agents (modified starches, maltodextrins), hydrocolloids (xanthan gum, guar gum, carrageenan, cellulose, etc.), emulsifiers (DATEM, mono and diglycerides, lecithin); salt, sugar, flavors and food colors (natural and artificial).

### Color Measurement:

It will be appreciated that color can be assessed in various ways. In some embodiments, a Hunter Colorimeter can be used to measure color values L* (Whiteness), a* (green to red) and b*(blue to yellow). The value for L* vary from 100 (White) to 0 (Black). The a* and b* have no specific numerical scale. Positive a* is red. Negative a* is green. Positive b* is yellow. Negative b* is blue. The higher the L* value the brighter and whiter the color.

In some embodiments, the opacifying compositions can have a brightness (L*) values of 70, 75, 80, 85, 90, and 95. In some embodiments, the brightness (L*) value can be in a range wherein any of the foregoing can serve as the upper or lower bound of the range. In an embodiment, the brightness (L*) values can be up to 85, 90, and 95.

In some embodiments, the opacifying compositions can have a yellowness (b*) values of −1.0, 0, 1.0, 2.0, 3.0, 4.0, and 5.0. In some embodiments, the yellowness (b*) value can be in a range wherein any of the foregoing can serve as the upper or lower bound of the range. In an embodiment, the yellowness (b*) values can be up to −1.0, 1.0 and 3.0.

In some embodiments, the opacifying compositions can have a redness (a*) values of −2.0, −1.0, −0.5 and 0. In some embodiments, the redness (a*) value can be in a range wherein any of the foregoing can serve as the upper or lower bound of the range. In an embodiment, the redness (a*) values can be up to −1.5, −1.0 and −0.5.

### Methods:

In an embodiment, a method of making a processed food product is included. The method can include adding an opacifying composition to a food formulation. The opacifying composition can include modified food starch with at least 70 wt. % dietary fiber and milk mineral concentrate with at least 24 wt. % calcium. The method can further include forming an emulsion with the formulation and the opacifying composition. The method can further include blending the emulsion with other components to form a mixture. The method can further include processing the mixture to form a finished product.

In some embodiments, the method can include placing the mixture within a food container. In some embodiments, the method can include hermetically sealing the mixture within a food container. Food containers can include, but are not limited to, cans, jars, tubs, boxes, pouches, bottles, glasses, and the like. The food containers can be opaque, translucent, transparent, or the like. In some particular embodiments, the food container is transparent.

In some embodiments, the method can include thermally processing the mixture. In some embodiments, the method can include thermally processing the mixture at a temperature of 190 degrees Fahrenheit or greater. In some embodiments, the temperature can exceed 200, 210, 220, 230, or 250 degrees Fahrenheit for at least about 5, 10, 15, 20, 25, or 30 minutes. In some embodiments, thermal processing can be performed at an elevated pressure. In some embodiments, the method can include retort cooking (or retorting) the mixture. In some embodiments, the method can include baking the mixture.

Aspects may be better understood with reference to the following examples. These examples are intended to be representative of specific embodiments, but are not intended as limiting the overall scope of embodiments herein.

### EXAMPLES

### Example 1: Opacifying Components—Opacity as a Function of Concentration

In this example, the opacity as a function of concentration was demonstrated for individual opacifying components by measuring their color values. Milk Mineral Concentrate Modified Food Starch-70% Fiber, and Titanium Dioxide solutions at varying concentrations were prepared in distilled water. The solutions were stirred well, filled into sample cup and the color (L*, a*, b*) was measured by Hunter Colorimeter. The pH was also measured for Milk Mineral Concentrate and Modified Food Starch-70% Fiber solutions. The results are shown in Table 2 and Table 3. As results indicate, a steep increase in opacity was observed up to 3% of concentration for both milk mineral concentrate and modified food starch and continue to increase with higher concentration. The pH values remained neutral and varied from 6.5-7.3. Similar results were observed for TiO2 dispersion as well.

TABLE 2

| | |
|---|---|
| Opacifying | Color |

| | | | | |
|---|---|---|---|---|
| Components | pH | L* | a* | b* |

Milk Mineral Conc.

| | | | | |
|---|---|---|---|---|
| 1% | 7.31 | 78.4 | −1.57 | −2.66 |
| 2% | 7.25 | 87.2 | −1.60 | −0.36 |
| 3% | 7.22 | 91.4 | −1.87 | 1.96 |
| 5% | 7.20 | 94.2 | −1.98 | 3.96 |
| 10% | 7.22 | 96.2 | −2.01 | 6.36 |

Modified Food
Starch -70% Fiber

| | | | | |
|---|---|---|---|---|
| 1% | 7.16 | 58.80 | −0.30 | 0.11 |
| 2% | 7.00 | 73.00 | −0.32 | 0.85 |
| 3% | 6.86 | 80.20 | −0.39 | 1.37 |
| 5% | 6.70 | 85.90 | −0.46 | 2.21 |
| 10% | 6.48 | 91.00 | −0.42 | 4.00 |

TABLE 3

| % TiO2 Dispersion | L* | a* | b* |
|---|---|---|---|
| 0.25% | 89.80 | −1.10 | 1.99 |
| 0.50% | 93.20 | −1.06 | 4.24 |
| 0.75% | 94.10 | −0.91 | 6.49 |
| 1.00% | 94.50 | −0.72 | 6.88 |

### Example 2: Opacifying Compositions and their Synergy

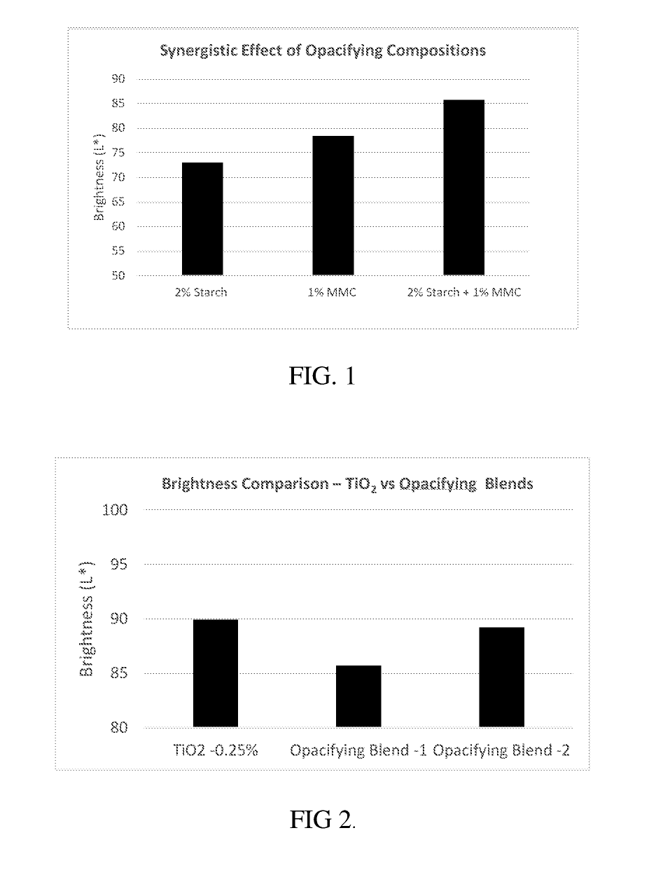

In this example, the synergistic effect of titanium dioxide free opacifying compositions is being demonstrated. 500 ml each of: (1) control—0.2% titanium dioxide (2) 1.0% Milk Mineral Concentrate (3) 2.0% Modified Food Starch; and (4) 1.0% Milk Mineral Concentrate+2.0% Modified Food Starch solutions were prepared. The solutions were stirred well, filled into sample cup and the color (L*, a*, b*) was measured by Hunter Colorimeter. The results as shown in FIG. 1 and Table 4 indicate a synergistic effect on increased brightness (L*) value, when modified food starch and milk mineral concentrate were combined together.

TABLE 4

| Ingredient | L* | a* | b* |
|---|---|---|---|
| Milk Mineral Conc. -1% Solution | 79.6 | −1.50 | −2.50 |
| Modified Food Starch - 2% Solution | 73.8 | −0.40 | −0.90 |
| Milk Mineral Conc. -1% + Modified Food | 85.7 | −1.10 | 0.50 |
| Starch -2% Solution | | | |
| TiO₂ - 0.2% Solution | 84.4 | −0.60 | 0.30 |

### Example 3: Opacifying Blends

In this example, several opacifying blends were prepared as per the formulations shown in table. The solutions were stirred well, filled into sample cup and the color (L*, a*, b*) was measured by Hunter Colorimeter. All opacifying blends have brightness (L*) values ranging from 85-95 as show in Table 5.

TABLE 5

| | Opacifying Blends (% by Wt.) | | | | | |
|---|---|---|---|---|---|---|
| Composition | Blend 1 | Blend 2 | Blend 3 | Blend 4 | Blend 5 | Blend 6 |
| Modified Food | 16.70 | 33.30 | 50.00 | 66.70 | 75.0 | 86.00 |
| Starch | | | | | | |
| Milk Mineral | 83.30 | 66.70 | 50.00 | 33.30 | 25.0 | 14.00 |
| Conc. | | | | | | |
| Total | 100.00 | 100.00 | 100.00 | 100.00 | 100.00 | 100.00 |
| % in Solution | 6 | 3 | 6 | 3 | 4 | 3.5 |
| Brightness (L*) | 95.4 | 89.20 | 92.70 | 85.70 | 87.80 | 85.75 |

### Example 4: Retort Process Tolerance of the Opacifying Compositions

In this example, the heat stability of titanium dioxide free opacifying compositions was evaluated. 500 ml each of: (1) control—0.2% titanium dioxide, (2) 2.0% Milk Mineral Conc., and (3) 3.0% Modified Food Starch solutions were prepared. The solutions were stirred well and filled into cans, sealed and retort processed in a pressure cooker at 250° F. for 20 minutes. The cans were cooled immediately after processing. The color measurements (L*, a*, b*) were taken on both pre- and post-retort processed samples using Hunter Colorimeter. The results shown in Table 6 below indicate no significant changes in color between pre-retort and post-retort samples, confirming their heat stability.

TABLE 6

| Ingredient | L* | a* | b* |
|---|---|---|---|
| TiO₂ - 0.2% Solution | | | |
| Pre-Retort | 84.4 | −0.6 | −0.3 |
| Post -Retort | 85.9 | −1.2 | 1.0 |
| Milk Mineral Conc. - | | | |
| 2.0% Solution | | | |
| Pre-Retort | 87.8 | −1.5 | −0.3 |
| Post - Retort | 86.1 | −1.7 | 0.1 |
| Modified Food Starch - | | | |
| 3% Solution | | | |
| Pre-Retort | 79.7 | −0.4 | 1.35 |
| Post-Retort | 69.4 | −0.9 | 1.69 |

### Example 5: Opacifying Capacity Comparison of Various Modified Food Starches

In this example, various starches were compared for the opacifying capacity both in their native and as well as in cooked forms. All starch solutions were prepared at 3% concentration by weight. The raw starch solutions were stirred, filled into sample cup and color was measured. Also, the starch solutions were heated in microwave for up to 90 sec to fully cook the starches. The samples were cooled and color was measured. The results as shown in Table 7, indicate that modified food starch (70% fiber) was shown to be the most stable and effective opacifier, compared to other native and modified food starches.

TABLE 7

| | Raw | | | Cooked | | | |
|---|---|---|---|---|---|---|---|
| Starch | L* | a* | b* | L* | a* | b* | Observations |
| Modified Food Starch- | 79.70 | −0.40 | 1.35 | 69.40 | −0.90 | 1.70 | Stable Color |
| 70% Fiber | | | | | | | No Viscosity |
| Rice Starch -Native | 89.70 | −0.60 | −0.40 | 43.40 | −1.70 | −10.60 | Increased Clarity |
| | | | | | | | Increased Viscosity |
| Waxy Rice Starch- | 83.40 | −0.40 | 7.49 | 25.10 | −0.90 | −1.26 | Increased Clarity, |
| Native | | | | | | | Increased Viscosity |
| Modified Food Starch -1 - | 79.00 | −0.60 | −0.50 | 27.30 | −0.60 | −3.60 | Increased Clarity, |
| Waxy Maize | | | | | | | Increased Viscosity |
| Modified Food Starch -2 | 81.40 | −0.60 | −0.04 | 31.20 | −0.70 | −3.80 | Increased Clarity, |
| | | | | | | | Increased Viscosity |
| Modified Food Starch - 3 | 81.30 | −0.70 | 0.10 | 30.10 | −0.80 | −4.80 | Increased Clarity, |
| | | | | | | | Increased Viscosity |

### Example 6: Opacifying Capacity of Milk Mineral Concentrate and Milk Permeates

In this example, opacifying capacity of Milk Mineral Concentrate and Milk Permeate with varying levels of Calcium content were compared. All solutions were prepared at 2% concentration by weight. The ingredient solutions were stirred, filled into sample cup and color was measured. The results as shown in Table 8, indicate that milk mineral concentrate (24% calcium) was shown to be the most effective opacifier when compared to other milk protein permeates.

TABLE 8

| | % Total | | | | |
|---|---|---|---|---|---|
| | Mineral | | Color Values | | |
| Ingredient | Content | % Calcium | L* | a* | b* |
| Milk Mineral Conc. | 73 | 24 | 87.8 | −1.50 | −0.30 |
| Low Mineral Milk | 9 | 0.38 | 14.7 | −1.90 | −0.60 |
| Permeate | | | | | |
| High Mineral Milk | 11 | 1.10 | 28.9 | −2.80 | −1.80 |
| Permeate | | | | | |

### Example 7: Opacification of Low Fat Cream Soups

In this example, a low fat Creamy Chicken Alfredo soup recipe (1 g Fat, 100 Calories) was used to evaluate the efficacy of titanium dioxide free opacifying compositions. The variables prepared include: a blank (B) without titanium dioxide; a control (C) with titanium dioxide dispersion at 0.6%; and a test variable (T) with opacifying blend (1% Milk Mineral Concentrate and 2% Modified Food Starch). The soup variables were prepared, filled into cans, sealed, and retort processed. The color measurements (L*, a*, b*) on processed soups were made using Hunter Colorimeter. The samples were evaluated by the team. As shown below in Table 9, addition of the opacifying blend to the formulation, significantly improved the overall opacity (brightness) of soup and found to be 90% as effective as TiO₂. The product made with opacifying blend was found to be acceptable in color, taste, and texture.

TABLE 9

| | Color | | | |
|---|---|---|---|---|
| Creamy Chicken Alfredo Soup | L* | a* | b* | pH |
| Blank - No Whitener | 63.30 | −0.38 | 19.10 | 5.94 |
| Control - with TiO2 | 85.90 | 1.05 | 12.76 | 5.94 |
| Test - with Opacifying Blend | 77.30 | 2.00 | 18.60 | 5.78 |

### Example 8: Opacification of Reduced-Fat Light Soups

In this example, a New England Clam Chowder (NECC) Light soup recipe (4 g Fat and 100 calories) was used to evaluate the efficacy of titanium dioxide free opacifying compositions. The variables prepared include: a blank (B) without titanium dioxide; a control (C) with titanium dioxide dispersion at 0.3%; and a test variable (T) with opacifying blend (1% Milk Mineral Conc. and 2% Modified Food Starch). The soup variables were prepared, filled into cans, sealed, and retort processed. The product made with opacifying blend was found to be acceptable in color, taste, and texture.

### Example 9: Pastel Color Application for Baked Snacks

In this example, a light pink pastel color composition was prepared as shown in Table 10. 100 g of original uncolored goldfish crackers were obtained and placed in a pan coater. The pink pastel color solution was applied onto the goldfish crackers as a thin layer with a spray, while they were rotating in the pan coater. The thinly coated crackers were dried in the oven at 85-90 degrees C. for 15-30 min. The dried crackers were taken back to the pan coater and the color was applied and then dried. The color application and drying was repeated several times (6-8 cycles) until crackers with uniform color were obtained.

TABLE 10

| | | Color Values | | |
|---|---|---|---|---|
| Pastel Color Composition | % Formula | L* | a* | b* |
| Purple Carrot Juice Conc. -42 Brix | 1.00 | 37.00 | 31.80 | −2.80 |
| Instant Starch Thickener | 4.00 | | | |
| Opacifying Blend (MFS + MMC 1:1) | 4.00 | | | |
| Citric Acid* | 0.20 | | | |
| Water | 90.80 | | | |

Note:
*Citric acid used to stabilize the pink color.

The embodiments described herein are not intended to be exhaustive or to limit the invention to the precise forms disclosed in the following detailed description. Rather, the embodiments are chosen and described so that others skilled in the art can appreciate and understand the principles and practices.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

The claims are:

1. A processed food product comprising:
a modified food starch with at least 70 wt. % fiber, and
a milk mineral concentrate with at least 24 wt. % calcium;
wherein the brightness (L*) value of the processed food product is greater than 70.

2. The processed food product of claim 1, comprising at least about 50 wt. % moisture content.

3. The processed food product of claim 1, comprising from 1 wt. % to 6 wt. % of the modified food starch and milk the mineral concentrate combined.

4. The processed food product of claim 1, comprising a retorted food product.

5. The processed food product of claim 1, selected from the group consisting of reduced-fat/low-fat refrigerated and shelf-stable soups, shelf-stable cheese dips, shelf-stable white sauces, salad dressings, bakery products, and baked snacks.

6. The processed food product of claim 1, wherein the processed food product is titanium-dioxide free.

7. An opacifying composition comprising:
a modified food starch with at least 70 wt. % fiber, and
a milk mineral concentrate with at least 24 wt. % calcium;
wherein the brightness (L*) value of the composition is greater than 70.

8. The opacifying composition of claim 7, including 10 to 99 wt. % of the modified food starch.

9. The opacifying composition of claim 7, including 10 to 99 wt. % of milk mineral concentrate.

10. The opacifying composition of claim 7, the overall composition having a modified food starch:milk mineral concentrate ratio of about 2:1 to 6:1 by weight.

11. The opacifying composition of claim 7, the modified food starch comprising one or more of modified wheat starch, modified corn starch, modified potato starch, modified rice starch, and modified tapioca starch.

12. The opacifying composition of claim 7, the modified food starch is a cross-linked resistant starch (RS4) with at least 70% dietary fiber.

13. The opacifying composition of claim 7, the milk mineral concentrate having at least 85% of particles less than 5 um.

14. The opacifying composition of claim 7, the milk mineral concentrate having at least 99% of particle less than 15 um.

15. The opacifying composition of claim 7, the milk mineral concentrate comprising a calcium content of at least 24 wt. %.

16. A method of making a processed food product comprising:
adding an opacifying composition to a formulation, the opacifying composition comprising:
(a) modified food starch with at least 70 wt. % dietary fiber; and
(b) milk mineral concentrate with at least 24 wt. % calcium forming an emulsion with the formulation and the opacifying composition;
blending the emulsion with other components to form a mixture; and
processing the mixture to form a finished product.

17. The method of claim 16, further comprising hermetically sealing the mixture within a food container.

18. The method of claim 16, wherein processing comprises retorting the mixture.

19. The method of claim 16, wherein processing comprises baking the mixture.

20. The method of claim 16, wherein the processed food product contains less than 5 grams of fat per serving.

21. The method of claim 16, wherein the processed food product contains less than 100 calories per serving.
